(19) United States
(12) Patent Application Publication
(10) Pub. No.: US 2024/0362999 A1
(43) Pub. Date: Oct. 31, 2024

(54) VEHICLE DEVICE AND INFORMATION INTEGRATION METHOD

(71) Applicant: DENSO CORPORATION, Kariya-city (JP)

(72) Inventors: Keisuke KOZAWA, Kariya-city (JP); Takahisa Yamashiro, Kariya-city (JP); Shinichiro Ando, Kariya-city (JP); Atsushi Baba, Kariya-city (JP)

(21) Appl. No.: 18/766,278

(22) Filed: Jul. 8, 2024

Related U.S. Application Data
(63) Continuation of application No. PCT/JP2023/000164, filed on Jan. 6, 2023.

(30) Foreign Application Priority Data
Jan. 26, 2022 (JP) 2022-010143

(51) Int. Cl. G08G 1/01

(52) U.S. Cl. CPC G08G 1/0125

(57) ABSTRACT

By a vehicle device or an information integration method, internal information is acquired, the internal information is compared with external information, whether both of the internal information and the external information include information related to an identical target is determined, the information that is acquired from a plurality of different sources and related to the identical target is integrated.

### CROSS REFERENCE TO RELATED APPLICATIONS

The present application is a continuation application of International Patent Application No. PCT/JP2023/000164 filed on Jan. 6, 2023, which designated the U.S. and claims the benefit of priority from Japanese Patent Application No. 2022-010143 filed on Jan. 26, 2022. The entire disclosures of all of the above applications are incorporated herein by reference.

### TECHNICAL FIELD

The present disclosure relates to a vehicle device and an information integration method that integrate information obtained from different sources.

### BACKGROUND

Conventionally, in a comparative example, an information processing system has been proposed that uses image sensors mounted on a plurality of vehicles to identify an identical object contained in images captured by the plurality of vehicles for identifying a traffic event.

### SUMMARY

By a vehicle device or an information integration method, internal information is acquired, the internal information is compared with external information, whether both of the internal information and the external information include information related to an identical target is determined, the information that is acquired from a plurality of different sources and related to the identical target is integrated.

### BRIEF DESCRIPTION OF THE DRAWINGS

The above and other features and advantages of the present disclosure will become more apparent from the following detailed description made with reference to the accompanying drawings.

FIG. 1 is a diagram schematically showing an electrical configuration example of a vehicle device according to a first embodiment.

FIG. 2 is a diagram schematically showing an example of a peripheral environment of a subject vehicle.

FIG. 3 is a diagram showing a flow of an information integration process executed by the subject vehicle.

FIG. 4 is a diagram showing an example of internal information, external information, and integration information.

FIG. 5 is a diagram showing an example of setting a type.

FIG. 6 is a first diagram showing a schematic example of an aspect in which a danger is notified.

FIG. 7 is a second diagram showing a schematic example of an aspect in which a danger is notified.

FIG. 8 is a diagram schematically showing a schematic diagram of an aspect of extracting feature points of an object according to a second embodiment.

FIG. 9 is a diagram schematically showing an example of an aspect in which a risk is predicted based on feature points.

FIG. 10 is a diagram schematically showing an example of an aspect in which an identical target is determined based on feature points.

FIG. 11 is a diagram schematically showing an example of a peripheral environment of the subject vehicle according to a third embodiment.

FIG. 12 is a diagram showing a flow of an information integration adjustment process executed by the subject vehicle.

FIG. 13 is a diagram showing an example of setting a color tone.

FIG. 14 is a diagram showing an example of integration information with an adjusted information amount.

FIG. 15 shows an example of lane setting.

FIG. 16 is a diagram showing an example of transmission information in which the amount of information is adjusted.

### DETAILED DESCRIPTION

Now, by receiving information obtained outside a subject vehicle, as in the above-described information processing system, it is considered that each vehicle will be able to use information other than the information obtained by the subject vehicle itself for purposes such as risk prediction.

However, conventionally, information received from the outside was treated as information different from information acquired by the subject vehicle itself, and therefore information related to the identical target was treated separately.

One example of the present disclosure provides a vehicle device and an information integration method capable of integrating information that is related to the identical subject and is obtained from different sources.

According to one example embodiment, a vehicle device of an embodiment includes: an acquisition unit configured to acquire internal information detected by a sensor mounted on a subject vehicle; a comparison unit configured to compare the internal information with external information that is acquired outside the subject vehicle via a communication unit mounted on the subject vehicle; a determination unit configured to determine whether both of the internal information and the external information include information related to an identical target based on a comparison result by the comparison unit; and an integration unit configured to integrate the information that is acquired from a plurality of different sources and related to the identical target based on a determination result by the determination unit. Thereby, it is possible to integrate information that is related to the identical target and acquired from different sources.

Hereinafter, a plurality of embodiments will be described with reference to the drawings. In a first embodiment, a basic configuration and a process flow for integrating information will be described, and in second and third embodiments, details of modifications or extended examples will be described. Further, the configurations that are substantially common in each embodiment will be described with the same reference numerals.

### First Embodiment

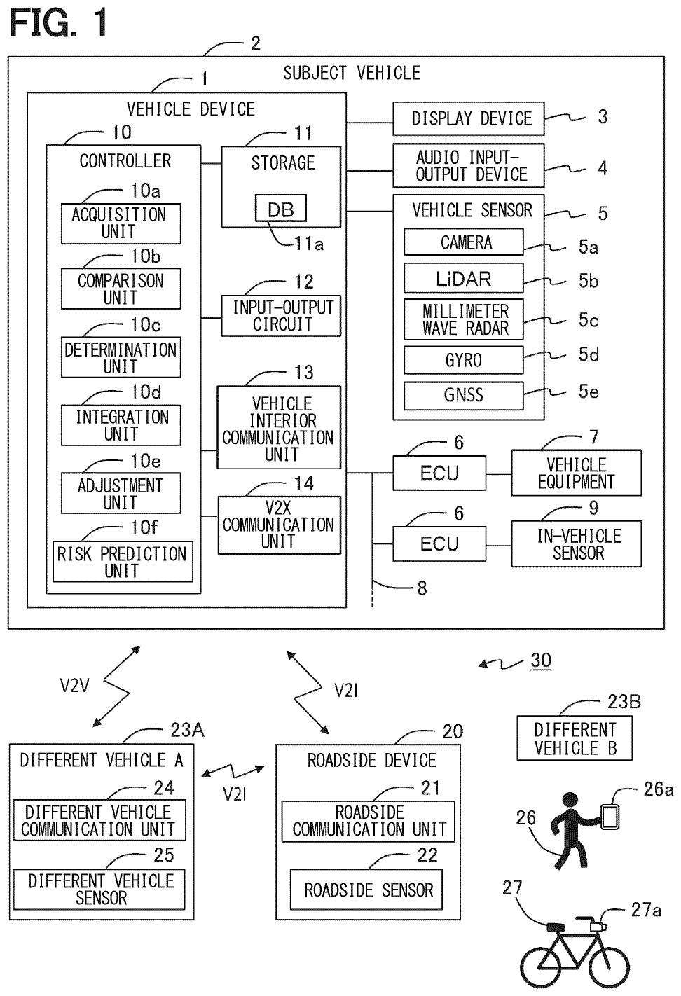

In the first embodiment, a basic configuration and a process flow for integrating information will be described. As shown in FIG. 1, a vehicle device 1 according to the present embodiment is mounted on a subject vehicle 2 and is connected to a display device 3, an audio input-output device 4, a vehicle sensor 5, a plurality of ECUs 6, and the like. The ECU is an abbreviation for electronic control unit. Further, although the vehicle device 1 is also one of the electronic devices provided in the subject vehicle 2 like the ECU 6, the two are distinguished here for the sake of explanation.

The display device 3 is, for example, a liquid crystal display, and receives image signals or video signals output from the vehicle device 1 to display an image or video. Further, the display device 3 also functions as an input device for inputting various operations to the vehicle device 1 using mechanical switches (not shown) and a touch panel provided in correspondence with a screen. In addition, in the present embodiment, the display device 3 is assumed to be attached to the center console, but it is also possible to adopt a so-called head-up display or a type that projects images onto the windshield, or to combine these with it.

The audio input-output device 4 includes a speaker and a microphone, and enables audio signals output from the vehicle device 1 to be reproduced to output audio, and enables operations to be input to the vehicle device 1 using the user's voice. The audio input-output device 4 can be used in common with or in combination with a device for so-called hands-free calling.

The vehicle sensor 5 includes sensors such as a camera 5a, a LIDAR 5b, a millimeter wave radar 5c, a gyro 5d, and a GNSS 5e. Note that LiDAR is an abbreviation for Light Detection And Ranging, and GNSS is an abbreviation for Global Navigation Satellite System. However, the vehicle device 1 does not necessarily need to include all of these, and it is sufficient if at least one of them is provided. In addition, the vehicle device 1 may include one or more of each of the sensors, such as the camera 5a, the LiDAR 5b, the millimeter wave radar 5c, and the gyro 5d.

These vehicle sensors 5 are well known and will not be described in detail, but the camera 5a captures images and videos of peripheral areas, such as areas in front of, behind, and to the sides of the subject vehicle 2. In the present embodiment, the camera 5a is capable of capturing the areas in color. The vehicle device 1 or the subject vehicle 2 may include the plurality of cameras 5a depending on the purpose, such as for the front, rear, or side. The LiDAR 5b measures the scattered light when a laser is irradiated onto an object, and detects the distance and direction to the object. The plurality of LiDARs 5b may be provided in the vehicle device 1 (here, the subject vehicle 2) for use in the front, rear, or sides depending on the purpose, or a rotating type LiDAR 5b capable of detecting the entire periphery of the vehicle may be provided. The millimeter wave radar 5c irradiates an object with millimeter waves and detects with high accuracy the distance to the object, its positional relationship with the subject vehicle 2, and the relative speed to the object. The vehicle device 1, in this case, the subject vehicle 2 may include the plurality of cameras 5a depending on the purpose, such as for the front, rear, or side. Further, the millimeter wave radar 5c may be configured to have different frequencies for different installation positions or different detection targets, for example. The GNSS 5e can obtain the position of the subject vehicle 2, the current time, and the like by receiving signals from artificial satellites, and is used, for example, for navigation control of the subject vehicle 2 and route guidance.

A plurality of ECUs 6 are provided in the subject vehicle 2 to control a vehicle equipment 7 of environmental and control systems, such as an air conditioner, a drive unit, or brakes. The ECUs 6 are connected to each other and to the vehicle device 1 via a vehicle interior network 8 so as to be able to communicate with each other and to the vehicle device 1. The ECU 6 may also be connected to an in-vehicle sensor 9 that detects, for example, the vehicle speed, acceleration, turning state, accelerator opening, and brake pedal operation state. Hereinafter, the vehicle sensor 5 and the in-vehicle sensor 9 will also be simply referred to as sensors.

Information detected by the in-vehicle sensor 9 can be acquired by the vehicle device 1 via the vehicle interior network 8. Hereinafter, the information acquired by the ECU 6 will also be referred to as vehicle information for convenience. In addition, the vehicle information can be used by other ECUs 6 via the vehicle interior network 8.

The vehicle device 1 can obtain information from the sensors. Hereinafter, information acquired by the subject vehicle 2 itself will be referred to as internal information, and internal information here means information acquired directly by the subject vehicle 2 itself. Therefore, even in a case where the information is about the outside of the subject vehicle 2, such as road conditions ahead, when it is information detected by the vehicle sensor 5 or the in-vehicle sensor 9, it becomes the internal information. Further, information such as the speed and traveling direction of the subject vehicle 2 is of course included in the internal information.

Further, the vehicle device 1 also includes a controller 10, a storage 11, an input-output circuit 12, a vehicle interior communication unit 13, and a V2X communication unit 14. The controller 10 is configured as a computer system including a CPU (Central Processing Unit), a ROM (Read Only Memory), a RAM (Random Access Memory), an input-output interface, and the like (not shown), and controls the entire vehicle device 1 by executing computer programs stored in the storage 11.

In addition, the controller 10 includes, in relation to the present embodiment, an acquisition unit 10a, a comparison unit 10b, a determination unit 10c, an integration unit 10d, an adjustment unit 10e, and a risk prediction unit 10f. In the present embodiment, each of these units is configured by software by executing a program. However, each unit can be configured with hardware, or can be configured with both software and hardware.

Although details will be described later, the acquisition unit 10a executes a process of acquiring information detected by the vehicle sensor 5 and the in-vehicle sensor 9 as the internal information at a predetermined cycle. The acquired internal information and the external information acquired and received outside the subject vehicle 2 are temporarily stored in, for example, a RAM. The comparison unit 10b executes a process of comparing the internal information acquired in the subject vehicle 2 with the external information acquired outside the subject vehicle 2. The determination unit 10c executes a process of determining whether the internal information and the external information contain information related to the identical target. At this time, the determination unit 10c determines whether the object is the identical target based on at least one or more pieces of information among the position, speed, orientation, and shape of the object contained in the internal information and the external information.

The integration unit 10d executes a process of integrating information related to the identical target that is included in the internal information and the external information but obtained from different sources. At this time, the integration unit 10d integrates at least one of information related to a mobile object in a periphery of the subject vehicle 2 detected by the camera 5a, LiDAR 5b, or the like, or information related to the vehicle 2 detected by the gyro 5d, GNSS 5e, or in-vehicle sensor 9, or the like. The details will be described later. In addition, the integration unit 10d integrates the internal information and the external information in at least one of two forms so that the information can be used to control the traveling of the subject vehicle 2 or can be used to notify the user. The details will be described later. Further, when different pieces of internal information and external information are acquired regarding the identical target, the integration unit 10d integrates the pieces of information based on the reliability of each piece of information. The details will be described later. However, the information to be integrated is not limited to being integrated based on the reliability alone, and can be integrated using other techniques, such as calculating an average of a parameter such as speed.

The adjustment unit 10e executes a process of selecting and discarding the integration information integrated by the integration unit 10d, and adjusting the amount of information to be transmitted. The details will be described later. The risk prediction unit 10f executes a process of predicting a risk based on at least one of the internal information, the external information, and the integration information, and a process of notifying the user of the predicted risk. Therefore, the risk prediction unit 10f also functions as a notification unit that notifies the user.

The storage 11 includes, for example, a semiconductor memory device such as an eMMC (embedded Multi Media Card) or a flash memory, or an HDD (Hard Disk Drive), and stores computer programs executed by the controller 10, various data required for processing executed by the controller 10, and the like. The storage 11 can also store information such as settings of the vehicle device 1. The input-output circuit 12 inputs and outputs signals between the controller 10 and peripheral devices such as the display device 3, the audio input-output device 4, and the vehicle sensors 5. For example, the input-output circuit 12 includes a signal conversion circuit that converts an electrical signal output from the controller 10 into an electrical signal that can be input to a peripheral device, and conversely, converts an electrical signal output from the peripheral device into an electrical signal that can be input to the controller 10. The vehicle interior communication unit 13 is implemented as an interface for communicating with the ECU 6 via the vehicle interior network 8. In the present embodiment, the vehicle interior communication unit 13 is assumed to use CAN communication, but other standards such as Ethernet (registered trademark) can also be used. The CAN is an abbreviation for Controller Area Network.

The V2X communication unit 14 is implemented as an interface for communicating with an external device located outside the subject vehicle 2, and in the present embodiment, it is assumed that V2X communication is performed. The V2X communication stands for Vehicle to Everything, a general term for communication technologies that connect vehicles with various devices and systems via wireless communication to enable mutual cooperation.

This V2X communication includes, for example, V2V (Vehicle to Vehicle), which performs communication between vehicles, V2I (Vehicle to Infrastructure), which performs communication between vehicles and infrastructure equipment such as roadside devices, V2P (Vehicle to People), which performs communication between vehicles and terminals owned by people, and V2N (Vehicle to Network), which performs communication between vehicles and a network.

However, the V2X communication unit 14 does not necessarily need to be compatible with all of the communication technologies described above. For example, in the present embodiment, the V2X communication unit 14 is compatible with V2V and V2I. Of course, the V2X communication unit 14 may be compatible with all of the above-described communication technologies. The V2X communication is carried out using Dedicated Short-Range Communications (DSRC), which is a dedicated narrow-area communication over a short distance, or a cellular system in which an area is divided into specific zones, a base station is set up in each zone, and communication is carried out between devices within the zone.

In the case of the vehicle device 1, communication can be performed with an external device capable of V2X communication and located in the vicinity of the subject vehicle 2. In this case, the external device may be, for example, a roadside device 20 installed near a road. In this case, the roadside device 20 includes a roadside sensor 21 that acquires information about the peripheral environment, and a roadside communication unit 22 that can transmit the information detected by the roadside sensor 21 to the subject vehicle 2.

Another example of the external device is a different vehicle 23A in the vicinity of the subject vehicle 2. The different vehicle 23A includes a different vehicle sensor 24 having a configuration similar to that of the vehicle sensor 5, and a different vehicle communication unit 25 compatible with V2I that can transmit information detected by the different vehicle sensor 24 to the roadside device 20. Information can be provided to the subject vehicle 2 via the roadside device 20. When the different vehicle communication unit 25 is compatible with V2V, the V2X communication can also be performed directly between the subject vehicle 2 and the different vehicle 23A.

In reality, it is also assumed that, in the periphery of the subject vehicle 2, there may be a different vehicle 23B, a pedestrian 26, a bicycle 27, and the like that are not compatible with V2X communication. However, when a portable communication terminal 26a carried by the pedestrian 26 or an image recording device 27a attached to the bicycle 27 is capable of communicating with, for example, V2P or the roadside device 20, then the portable communication terminal 26a and the image recording device 27a can also be considered as the external devices.

In this manner, the subject vehicle 2 is connected to external devices such as the roadside device 20 and the different vehicle 23A so as to be able to communicate with each other. Thereby, an information sharing system 30 is constructed and enables information acquired at multiple observation points, i.e., information acquired from different sources, to be shared and used by each other. At this time, the information received through V2X communication is basically considered to be information about the vicinity of the subject vehicle 2. Therefore, it is assumed that information regarding the identical target contained in the internal information acquired by the subject vehicle 2 is also contained in the external information acquired outside.

Next, an operation of the above-described configurations will be described. For example, external information acquired by the external device such as the roadside device 20 or the different vehicle 23A is received. As a result, it is expected that the subject vehicle 2 is able to obtain more detailed and accurate information than the internal information, and is able to acquire new information that is not included in the internal information. Further it is assumed that by utilizing this external information, it is possible to, for example, predict the risk with greater accuracy.

By the way, the received external information is basically considered to be information about the vicinity of the subject vehicle 2. Therefore, it is expected that external information will contain information about the identical target that has already been obtained as the internal information. In such a case, when the external information is treated separately as information distinct from internal information, even information relating to the identical target is required to be processed separately. The information processing load is likely to increase or the processing is likely to be delayed.

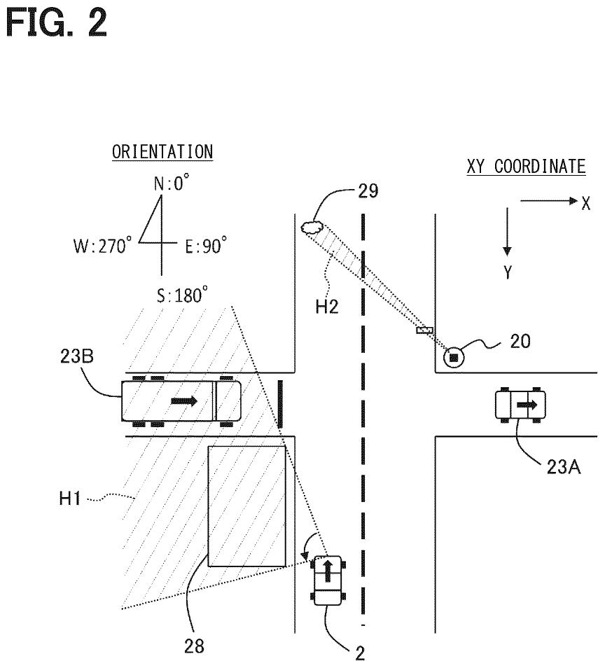

Therefore, the vehicle device 1 integrates information about the identical target that is included in the internal information and the external information obtained from different sources. Hereinafter, the information integrated in the vehicle device 1 will be referred to as integration information. However, the integration in this case means aggregating information about the identical target from internal information and external information so that the same process does not need to be executed repeatedly on the identical target. A specific method for the vehicle device 1 to integrate information will be described below. However, to facilitate understanding, first, a hypothetical situation is assumed, and may occur while the subject vehicle 2 is traveling, as shown in FIG. 2. A flow of processes will be described in accordance with that situation.

As shown in FIG. 2, when north is 0°, east is 90°, south is 180°, and west is 270°, the subject vehicle 2 is traveling north on a two-lane road. Black arrows superimposed on each vehicle indicate their respective directions of travel. In addition, an XY coordinate system is set with a predetermined reference position as the origin, with the X direction being to the right of the traveling direction, i.e., eastward, and the Y direction being opposite the traveling direction of the subject vehicle 2, i.e., southward. Note that the XY coordinate system has been set for convenience in order to make the explanation easier to understand, but the XY coordinate system can be set by converting the latitude and longitude obtained by a GNSS 5e into the distance from a reference position.

Further, in the assumed peripheral environment of the subject vehicle 2, an intersection exists ahead of the subject vehicle 2. The roadside device 20 is installed in the vicinity of the intersection. The different vehicle 23A is traveling to the right, that is, east, from the intersection. It is assumed that different vehicle 23B is traveling from the left toward the intersection, that is, toward the east. In addition, a building 28 is present on the left side of the subject vehicle 2 in the vicinity of the intersection. A range (H1) indicated by the dashed hatching is an area in which detection by the vehicle sensor 5 is impossible or difficult due to the building 28. Further, it is assumed that there is a road sign in the vicinity of the roadside device 20, and that a range (H2) indicated by the dashed hatching is difficult for the roadside sensor 21 to perform detection due to the road sign, and that a fallen object 29 exists in that range (H2).

That is, FIG. 2 schematically shows a situation in which there are the different vehicle 23A, which is an object that can be detected by both the subject vehicle 2 and an external device such as the roadside device 20, the different vehicle 23B, which is an object that cannot be detected by the subject vehicle 2 but can be detected by the roadside device 20, and the fallen object 29, which is an object that can be detected by the subject vehicle 2 but cannot be detected by the roadside device 20. In other words, FIG. 2 schematically shows a situation in which information regarding the different vehicle 23A is included in both the internal information and the external information, information regarding the different vehicle 23B is included in the external information but not in the internal information, and information regarding the fallen object 29 is included in the internal information but not in the external information. However, the situation shown in FIG. 2 is just one example.

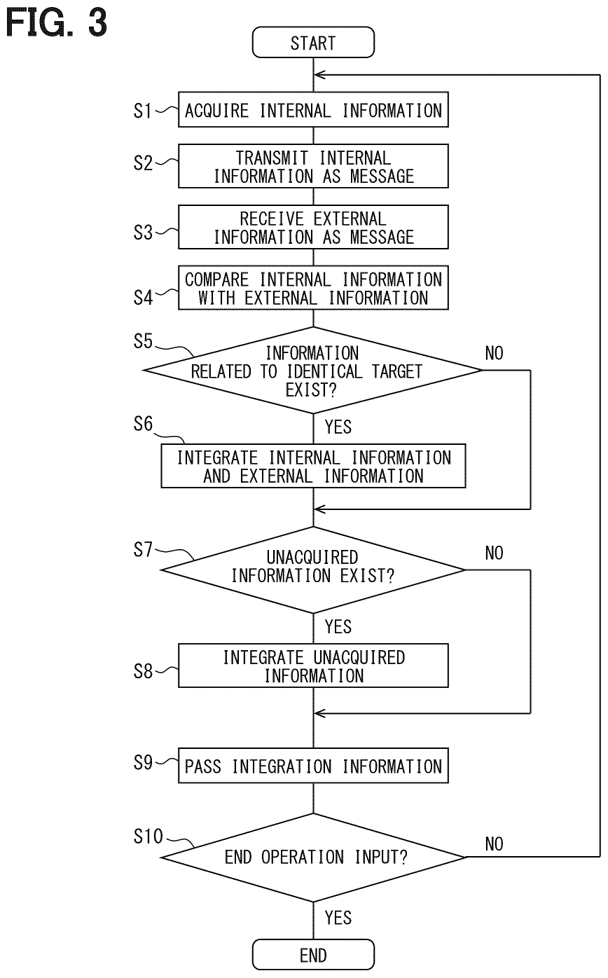

The vehicle device 1 executes an information integration process shown in FIG. 3 in order to integrate the internal information and the external information. Although this information integration process is executed by the comparison unit 10b, determination unit 10c, integration unit 10d, and adjustment unit 10e, and the like, described above, the following description will be focused mainly on the vehicle device 1 for the sake of simplicity.

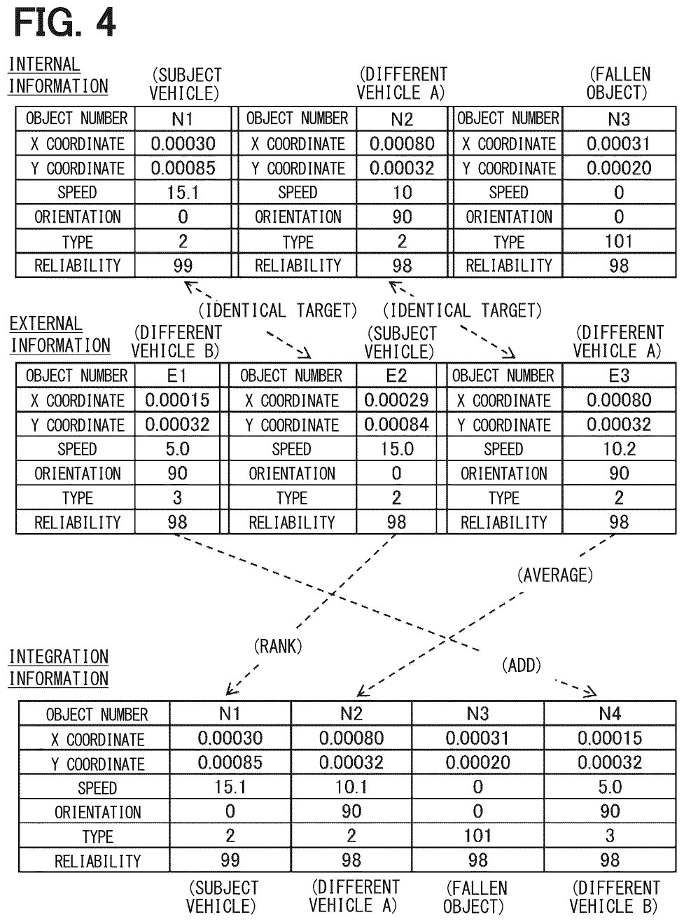

When the vehicle device 1 starts processes after being powered on, the vehicle device 1 acquires the internal information (S1). At this time, as shown in FIG. 4, it is assumed that the vehicle device 1 acquires, as the internal information, information on the X coordinate, Y coordinate, speed, direction, type, and reliability of three objects N1, N2, and N3, for example. The method of acquiring the internal information will be described in the second embodiment later. However, the internal information is set to mainly reduce the load on V2X communication, since when, for example, image data acquired by the subject vehicle 2 is transmitted or received, a shortage of bandwidth for V2X communication or a high load on processing the received information may occur. Further, the types and numbers of pieces of information included in the internal information shown in FIG. 4 are merely examples. The X and Y coordinates indicate a position in the above-described XY coordinate system, the speed indicates the movement speed of the object, and the orientation indicates the movement direction of the object. The type indicates the type of object, and is set as an identification number corresponding to the type of object. In the present embodiment, the types are set so that 0 is a mobile object, 1 is a motorcycle, 2 is a passenger car, 3 is a truck, 4 is a bus, 5 is a trailer, 6 is an emergency vehicle, 7 is a person, 8 is the bicycle 27, 100 is a stationary object, 101 is the fallen object 29 in the same lane as the subject vehicle 2, and 102 is the fallen object 29 in the other lane.

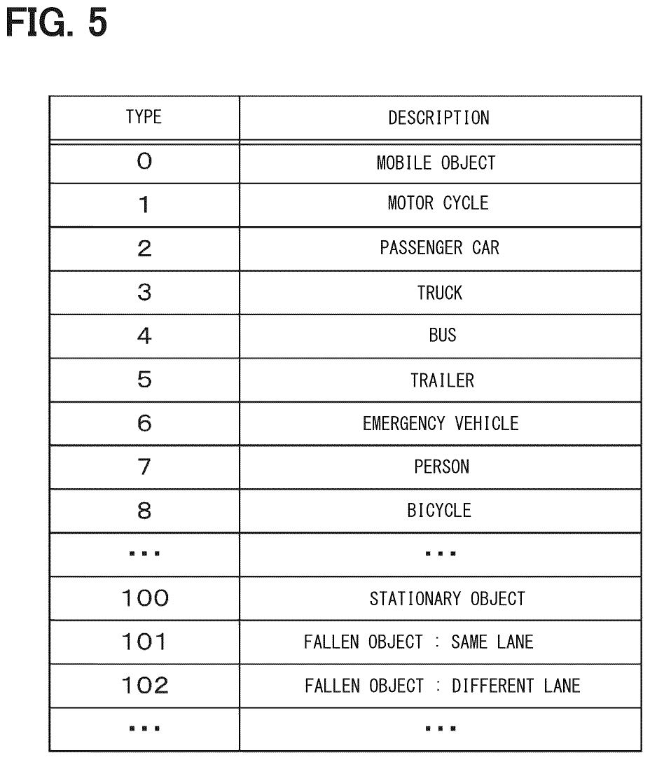

Therefore, when the type is known, it is possible to identify the shape of the object to some extent. Further, by indicating the type of object by its classification, it becomes possible to notify the outside of information about the object and to obtain information about the object from the outside without transmission or reception of relatively large amounts of information such as image data. It is assumed that the type is set in a common manner in the information sharing system 30. In addition, 0 is set assuming the mobile object whose type cannot be identified, and 100 is set assuming a stationary object whose type cannot be identified. However, the types shown in FIG. 5 are merely examples, and the settings can be based on regulations such as the Road Traffic Act and the Vehicle Act, or common standards and specifications for using V2X communication.

The reliability indicates the accuracy of the information. As one example, it is conceivable that the speed of the mobile object can be obtained by performing image processing on an image captured by the camera 5a. However, generally, it is considered that the speed measured by, for example, the millimeter wave radar 5c is more accurate than the speed obtained by image processing.

Therefore, the reliability of the speed measured by the millimeter wave radar 5c is set relatively higher than that of the speed determined by image processing. Further, even when the same millimeter wave radar 5c is used, it is considered that the higher the resolution, the higher the accuracy. Therefore, the reliability is set as a relative value taking into consideration the detection capabilities of the vehicle sensor 5 and the roadside sensor 21 and measurement conditions such as the position and orientation at which these sensors are attached.

In the above-described situation shown in FIG. 2, the vehicle device 1 acquires information about the different vehicle 23A and the fallen object 29 that are present within the detection range. In addition, as described above, the vehicle device 1 also acquires vehicle information of the subject vehicle 2 as internal information, and therefore information on three objects, N1 corresponding to the subject vehicle 2, N2 corresponding to the different vehicle 23A, and N3 corresponding to the fallen object 29, is acquired as internal information.

Then, as shown in FIG. 3, the vehicle device 1 transmits internal information to the outside as a V2X communication message (S2), and receives external information as a V2X communication message (S3). At this time, the vehicle device 1 encodes the information using, for example, a Collective Perception Message (CPM). In this way, the vehicle device 1 transmits internal information to the external device via V2X communication and also acquires external information from the external device via V2X communication, thereby enabling information sharing. However, the processes of steps S1 and S2 and the process of S3 can be executed in any order.

In the situation shown in FIG. 2, the vehicle device 1 transmits and receives messages to and from the roadside device 20. Therefore, the message received from the roadside device 20 contains information about three objects: E1 corresponding to the different vehicle 23B, E2 corresponding to the subject vehicle 2, and E3 corresponding to the different vehicle 23A, as shown in FIG. 4. However, the types and numbers of pieces of information included in the external information shown in FIG. 4 are merely examples.

Next, as shown in FIG. 3, the vehicle device 1 compares the internal information with the external information (S4) and determines whether the internal information and the external information contain information on the identical target (S5). This process is carried out by the comparison unit 10b and the determination unit 10c. Specifically, the vehicle device 1 compares, for example, the information N1, N2, and N3 acquired as internal information shown in FIG. 4 with the information E1 to E3 acquired as external information.

Then, when the internal information and external information have the same information such as X coordinate, Y coordinate, speed, direction, and type, for example, between N1 and E2 or N2 and E3, or when the two are within a range that is considered to be roughly the same, the vehicle device 1 determines that they are the identical target. That is, the vehicle device 1 determines whether they are the identical target based on the similarity of vectors of the objects described in the second embodiment.

In other words, the vehicle device 1 determines whether the objects are the identical target based on information about the object observed from different perspectives, such as the object position, speed, and orientation, contained in the internal information and external information. However, it is not necessary to include all information in the comparison target. For example, only the positions may be compared, or the positions and speeds may be compared, and the comparison may be appropriately set or selected. Moreover, it is also possible to weight each piece of information, and determine whether the pieces of information are the identical target based on the result obtained by weighting the degree of coincidence of each piece of information.

When it is determined that the internal information and the external information include information of the identical target (S5: YES), the vehicle device 1 integrates the internal information and the external information (S6). At this time, the vehicle device 1 integrates the internal information and the external information in accordance with a predetermined condition, such as by ranking the information or averaging the information. In other words, the vehicle device 1 integrates information about the mobile object, including information about the subject vehicle 2.

Thereby, it is possible to identify an object approaching the subject vehicle 2, for example, and use the information for risk prediction. Further, when the information about the subject vehicle 2 is included in the external information, it can be confirmed that the subject vehicle 2 is at least recognized by the transmission source of the external information, and when the information about the subject vehicle 2 included in the internal information and the external information matches with each other, it can be confirmed that the information sharing system 30 is operating normally.

Specifically, in a case where the internal information and external information shown in FIG. 4 are acquired, it is determined that N1 and E2 are the identical target and the information is integrated, the reliability of N1 is higher than the reliability of E2, so the vehicle device 4 prioritizes the internal information with higher reliability over the external information. As a result, as shown as the integration information, the same information as the internal information is stored for N1.

That is, when different pieces of internal information and external information are acquired regarding the identical target, the vehicle device 1 integrates the pieces of information based on the reliability of each piece of information. In this case, by excluding the information of E2 contained in the external information, the amount of information about the identical target is reduced compared to the state in which it is distributed into the internal information and the external information.

Further, when the reliability is the same for N2 and E3 but there is a slight difference in speed, for example, the vehicle device 1 integrates them by averaging them. Thereby, the average value of the internal information and external information is stored for the speed of N2, shown as the integration information.

The vehicle device 1 also stores, as integrated information, information that is included in the internal information but not included in the external information. For example, even when the external information does not include information corresponding to N3, the vehicle device 1 stores N3 as the integration information since the reliability of N3 is high and N3 is correct information. That is, the vehicle device 1 also integrates information about the stationary object.

Now, when the vehicle device 1 integrates information relating to the identical target in S6, or when it determines in S5 that no information relating to the identical target is included (S5: NO), it determines whether there is any unacquired information in the external information (S7). Here, the unacquired information refers to information that is not included in the internal information but is included in the external information. For example, in the case of the different vehicle 23B shown in FIG. 2, since the different vehicle 23B is located in the range (H1) that cannot be detected by the subject vehicle 2, it is not included in the internal information as shown in FIG. 4, but is included in the external information as E1.

In this case, since there is no internal information related to the object corresponding to E1, the vehicle device 1 determines that there is the unacquired information (S7: YES), and integrates the information related to E1 as the unacquired information (S8). Specifically, the vehicle device 1 adds information on E1, which corresponds to the unacquired information, to the integration information as N4, which indicates a fourth object existing in the vicinity of the subject vehicle 2. That is, when integrating information, information that overlaps between the internal information and the external information is eliminated. On the other hand, information that is included in either one is stored as the integration information. Thereby, it is possible to grasp the object that cannot be detected by the subject vehicle 2.

Then, the vehicle device 1 passes the integration information to, for example, the risk prediction unit 10f, the ECU 6 that controls the drive system, or the brake system (S9). That is, the vehicle device 1 integrates the internal information and the external information into a state that can be used to notify the user and a state that can be used to control the traveling of the subject vehicle 2. Thereby, it is possible for the subject vehicle 2 to use the internal information and the external information, which are separate pieces of information obtained from different sources, as a single integrated piece of information.

One possible use of the integration information is in the risk prediction process. For example, as shown in FIG. 2, when the different vehicle 23B that is not detected by the vehicle 2 is approaching an intersection, the risk prediction unit 10f can determine the relative position between the subject vehicle 2 and N4, as well as the type, direction and speed of N4 by referring to the integration information.

In other words, by integrating the external information and sharing the information detected by sensors for the external device, the risk prediction unit 10f becomes able to predict potential risks that has not been detected by the subject vehicle 2. In addition, the risk prediction unit 10f is capable of predicting the risk to the subject vehicle 2 by processing the integrated information. Therefore, there is no need to perform separate processing for the internal information and the external information, and it is possible to prevent duplication and delays in processing.

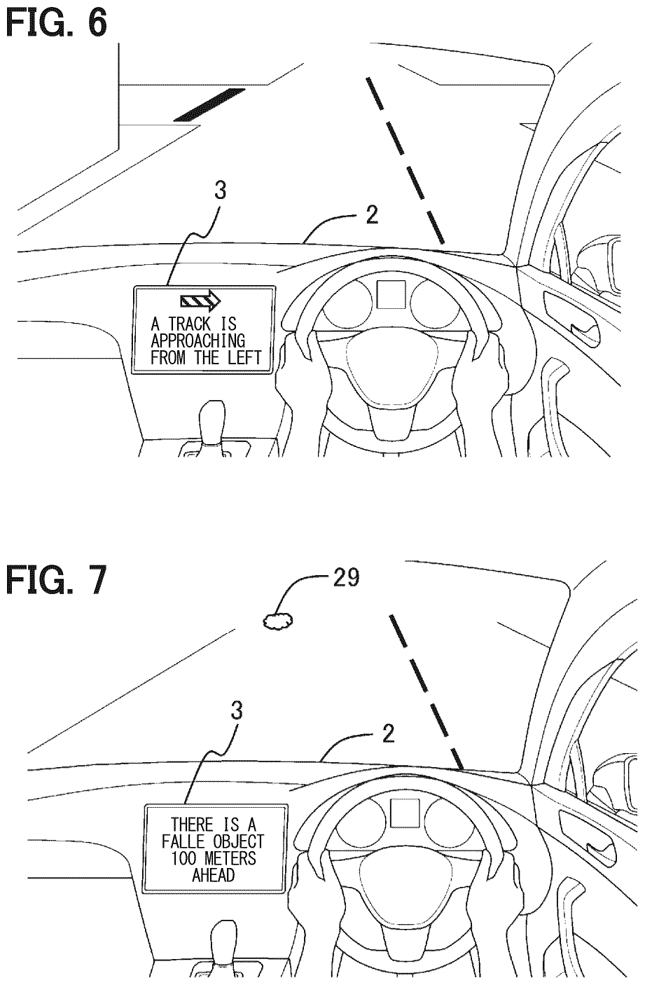

Then, when the risk prediction unit 10f detects, for example, that there is a possibility that a truck will enter the road on which the subject vehicle 2 is traveling, it predicts the possibility of a collision. Therefore, for example, as shown in FIG. 6, a message such as “A truck is approaching from the left” can be displayed on the display device 3 to notify the user of the risk. Alternatively, the risk prediction unit 10f predicts the possibility that the fallen object 29 not included in the external information is likely to come into contact with the subject vehicle 2. Therefore, for example, as shown in FIG. 7, by displaying a message such as “There is a fallen object 100 meters ahead” on the display device 3, it is possible to notify the user of the risk. However, the display method on the display device 3 is not limited to the method of displaying characters as shown in FIG. 6 or FIG. 7. For example, the risk can be notified using a graphical display method, such as displaying an illustration of a vehicle together with an illustration of, for example, a star or cloud that shows the manner in which the collision occurred, or using a number of different notification methods combined with audio notifications.

In this way, the vehicle device 1 integrates internal information and external information. Thereby, it is possible to share information detected by the sensor or the like of the external device with the subject vehicle 2. As described above, it is possible to improve the accuracy and reliability of risk prediction, for example by making it possible to predict risks that has not been detected by the subject vehicle 2 itself. Further, the risk prediction unit 10f can also notify the user of the risk by outputting a sound from the audio input-output device 4.

In addition, the vehicle device 1 can transfer the integration information to the ECU 6 to perform, for example, accelerator control and brake control based on the integration information. In this case, since the ECU 6 only needs to process the integration information, it is possible to grasp and determine the situation more quickly than when it were to process the internal information and the external information separately. As a result, it is possible to quickly control the subject vehicle 2, and avoid the risk, that is, improve the safety.

According to the above-described embodiment, the following effects can be obtained. The vehicle device 1 includes: the acquisition unit 10a that acquires information detected by the sensor provided in the subject vehicle 2 as the internal information; the comparison unit 10b that compares the internal information with the external information that is acquired outside the subject vehicle 2 and is received via a communication unit provided in the subject vehicle 2; the determination unit 10c that determines whether the information related to the identical target is included in both the internal information and the external information based on the comparison result by the comparison unit 10b; and the integration unit 10d that integrates information that is acquired from different sources and related to the identical target based on a result of the determination by the determination unit 10c.

Thereby, the vehicle device 1 can integrate information related to the identical target among objects in the internal information and the external information that are acquired from different sources. For example, it becomes possible to carry out processing related to the identical target based on a single piece of information. In addition, by processing the internal information and the external information separately, duplication or repetition of processing for the identical target is prevented. Thereby, it is possible to reduce the risk of increase in the processing load and delay in processing. That is, the vehicle device 1 can quickly process information about the identical target.

Furthermore, when the information related to the identical target can be processed quickly, it becomes possible, for example, to quickly predict the risk and quickly control the subject vehicle 2 to respond to the predicted risk, and thereby becomes possible to improve the safety. Further, the integration unit 10d of the vehicle device 1 integrates information related to the mobile object. It is possible to identify an object approaching the subject vehicle 2, for example, and use the information for risk prediction.

In addition, the integration unit 10d of the vehicle device 1 integrates information related to the subject vehicle 2. Thereby, when the information about the subject vehicle 2 is included in the external information, it can be confirmed that the subject vehicle 2 is at least recognized by the transmission source of the external information, and when the information about the subject vehicle 2 included in the internal information and the external information matches with each other, it can be confirmed that the information sharing system 30 is operating normally.

Further, the integration unit 10d of the vehicle device 1 integrates the information into a state that can be used to control the traveling of the subject vehicle 2. Thereby, for example, when the object that has not been detected by the subject vehicle 2 is identified, it becomes possible to deal with potential risk by performing accelerator control or brake control based on the integration information. It is possible to improve the safety.

Further, the integration unit 10d of the vehicle device 1 integrates the information into the state that can be used to notify the user. Thereby, it is possible to, for example, notify the driver of the risk of the object that has not been detected by the subject vehicle 2. It is possible to improve the safety.

Further, when different pieces of internal information and external information are acquired regarding the identical target, the integration unit 10d of the vehicle device 1 integrates the pieces of information based on the reliability of each piece of information. Thereby, it is possible to improve the reliability of the information, and also it possible to use highly reliable information for, for example, risk prediction and control of the subject vehicle 2, so that it is possible to further improve the safety.

Further, the integration unit 10d of the vehicle device 1 integrates information that is not included in the internal information but is included in the external information as unacquired information. Thereby, it is possible to identify the object that has not been detected by the subject vehicle 2, improve the accuracy of risk prediction and control the subject vehicle 2 to avoid the risk, so that it is possible to further improve the safety.

Further, the integration unit 10d of the vehicle device 1 integrates information that is included in the internal information but not included in the external information as the unacquired information. Thereby, it is possible to prevent the information detected by the subject vehicle 2 from being discarded even when detection was performed by the subject vehicle 2 and the external information does not included the identical target. It is possible to improve the accuracy of risk prediction and control the subject vehicle 2 to avoid risk, and further improve the safety.

Further, the information integration method is for integrating information obtained from different sources in a vehicle, and includes: acquiring information detected by the sensor provided in the subject vehicle 2 as the internal information; comparing the internal information with the external information that is acquired outside the subject vehicle 2 and is received via a communication unit provided in the subject vehicle 2; determining whether the internal information and the external information both contain information related to the identical target; and integrating information that has been acquired from different sources and related to the identical target based on a result of the determination.

According to the information integration method described above, it is possible to obtain effects similar to the above-described effects by the vehicle device 1. The effects include an effect that, when the information related to the identical target can be processed quickly, it becomes possible, for example, to quickly predict the risk and quickly control the subject vehicle 2 to respond to the predicted risk and an effect that it becomes possible to improve the safety. Although the configuration in which the acquired internal information is transmitted has been exemplified, the configuration may be such that integration information that has already been stored and updated with the acquired internal information is transmitted.

### Second Embodiment

Hereinafter, the second embodiment will be described. In the second embodiment, a method for setting internal information and its utilization will be described. Although the external information is set in a similar manner, here, for the sake of simplicity, the setting in the vehicle device 1 will be described as an example. That is, the second embodiment can be combined with the first embodiment.

The vehicle device 1 extracts features from the acquired image and performs object detection, feature extraction, modality processing, compact representation generation, similarity scoring, identification, and association processing to set the classification. Although these processes are executed by the controller 10 using software, it is also possible to provide hardware such as an image processing IC to execute the processes.

The vehicle device 1 captures an image of the periphery using the camera 5a provided in the subject vehicle 2. At this time, the vehicle device 1 acquires images by capturing images with the camera 5a at preset image capturing intervals, such as 5 second intervals, 10 second intervals, 30 second intervals, and the like. When the image is captured, the vehicle device 1 identifies one or more objects contained in the captured image, and extracts features of the identified objects. The feature extraction method described below is a common method in the field of image processing, so it will be described here in a simplified manner to allow the processing flow to be understood.

The vehicle device 1 extracts a set of multi-modal features from the identified object. Multimodal features are also called modality features. Specifically, the vehicle device 1 normalizes the modality features to generate an initial feature vector (V). This initial feature vector includes, for example, a position and a movement direction of an object, texture features, color features, context features, viewpoint features, and the like.

The position of the object corresponds to the X and Y coordinates included in the internal information, and the movement direction corresponds to the orientation included in the internal information. Texture features are described as textures that represent various parts of an object, such as the hood, wheels, or bumpers, and may be geometric shapes, structures, or texture patterns. A color feature is what describes the color of an object.

The context features describe the background environment in the periphery of the object, for example, indicate a situation where the different vehicle 23 is traveling through an intersection. The viewpoint feature indicates the viewpoint from which an image including an object was captured, and includes the movement direction of the subject vehicle 2, the mounting position of the camera 5a, and the orientation when the image was captured.

Next, the vehicle device 1 then performs compact representation generation based on the extracted features. This compact representation generation is a process of generating a compact feature vector capable of expressing an object identified from an image in a compact state, that is, with a reduced amount of information. At this time, in the vehicle device 1, a so-called learning model is generated in order to enable efficient generation of the compact representation. This compact feature vector is used to identify, for example, the X coordinate, Y coordinate or type contained in the internal information.

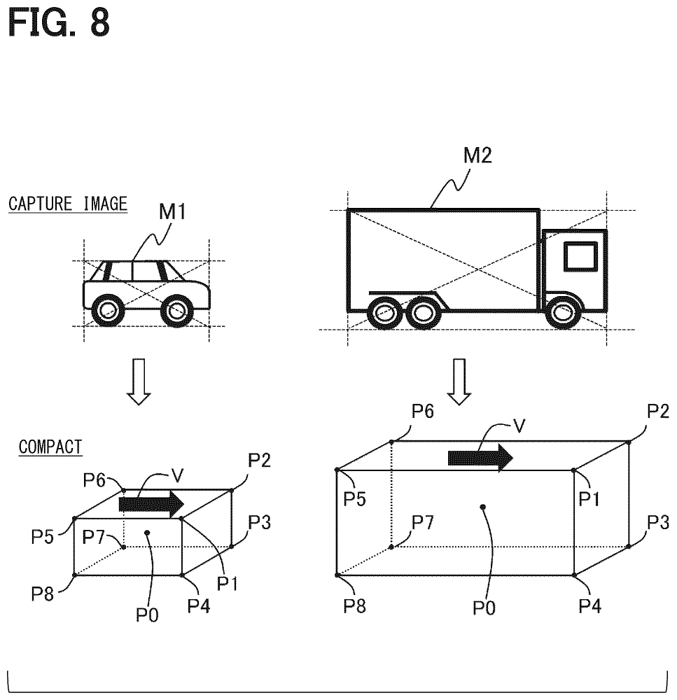

For example, as shown in the captured image in FIG. 8, it is assumed that an extract object M1 corresponding to a regular automobile and an extract object M2 corresponding to a truck are identified from an image captured by the camera 5a. In this case, the vehicle device 1 can acquire the above-described texture features and color features for each object. Thereby, the vehicle device 1 determines the appearance and size of the object by identifying the position of the wheels, and the like from the texture features, and identifying the relative position with respect to the subject vehicle 2, or the like from the context features.

Then, by identifying the type of vehicle that corresponds to the obtained size and appearance of the object, the classification can be set. In other words, by using type information, which has an overwhelmingly smaller amount of information than image data, it is possible to transmit and receive information capable of identifying the type of object while reducing the communication load. In other words, the information acquired by the sensor is converted into conversion information in a state where the characteristics of an object that can be identified by the information can be grasped and the amount of information is reduced compared to when the information was acquired. By performing communication using the conversion information, each device included in the information sharing system 30 can share information while reducing the communication load.

Furthermore, when the type can be identified, the center position of the object can be estimated. For example, when the distance is measured by the millimeter wave radar 5c, the distance from the subject vehicle 2 to the surface of the object is detected. However, when the distance is transmitted, the value is likely to contain an error for, for example, the different vehicle 23 that is at a different position from the subject vehicle 2. Therefore, the vehicle device 1 determines the center position of the object so that it can be used generally in the different vehicle 23 and the like.

Specifically, for example, the extract object M1 is determined to be a passenger car. Therefore, by adding the distance to the detected object and half the width associated with the type, a center position (P0) of the extract body M1 can be obtained as shown as a compaction in FIG. 8. Further, once the center position is determined, it becomes possible to identify the coordinates of each vertex (P1 to P8) of a rectangular parallelepiped that connects the outer edge of the object, that is, the three-dimensional shape of the object. The coordinates of this center position (P0) become the X and Y coordinates contained in the internal information.

Similarly, the center position (P0) of the extract object M2 is determined. Further, once the center position is determined, the coordinates of each vertex (P1 to P8) of the rectangular parallelepiped that connects the outer edge of the object can be specified. Furthermore, the compact feature vector represented by the center position and each vertex makes it possible to provide information capable of identifying the three-dimensional shape of an object with a smaller amount of information than image data.

Then, the compact feature vector is associated with the initial feature vector indicated by the black arrow. Thereby, it is possible to transmit the summarized internal information of an object to the external device as a message, and to receive the summarized internal information from the external device as the message. As a result, each vehicle can determine whether the objects are the identical target by identifying the center position and type of the object. In other words, it is possible to share information that enables grasping the characteristics of the object in a compact form without transmitting and receiving image data to and from the subject vehicle 2 itself.

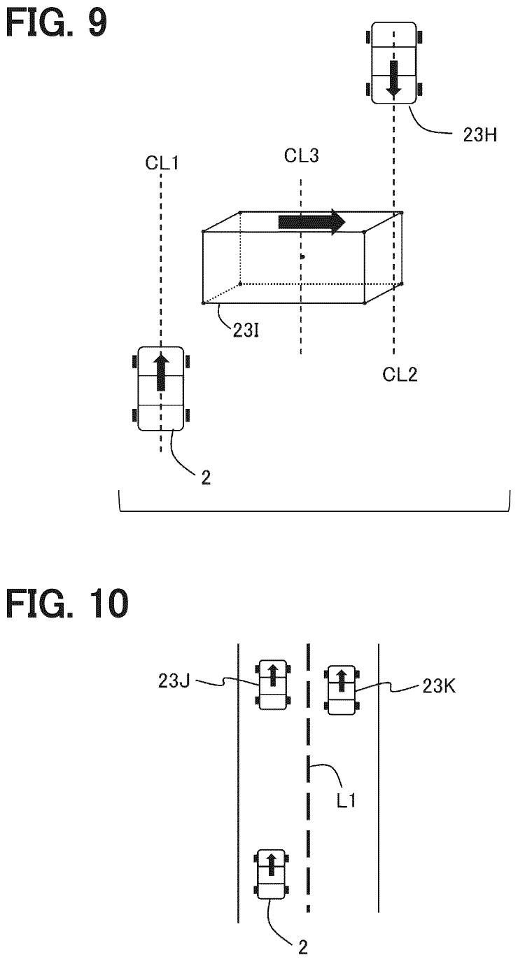

It is also possible to calculate the positional relationship and orientation of the object in relation to itself, as well as the three-dimensional shape of the object. Thereby, it becomes possible to enable each vehicle to better utilize the acquired information for vehicle control and hazard prediction. For example, as shown in FIG. 9, a situation is assumed in which the subject vehicle 2 and a different vehicle 23H are traveling in opposite directions, and a different vehicle 231 is crossing between them. At this time, when viewed from the center position of the object, the center position of the subject vehicle 2 indicated by line (CL1) and the center position of the different vehicle 23H indicated by line (CL2) are shifted from the center position in the front-rear directions of the different vehicle 231 indicated by line (CL3).

In this case, the center position of the subject vehicle 2 is shifted from the center position of the different vehicle 231, and also shifted from the rear end of the different vehicle 231 in the three-dimensional shape. Therefore, it can be determined that there is little risk of contact, and the like. On the other hand, although the center position of the different vehicle 23H is shifted from the center position of the different vehicle 231, it can be seen that the center position of the different vehicle 23H overlaps with the leading edge of the different vehicle 23 in the three-dimensional view.

In other words, when the positional relationship between the different vehicles 23H and 231 remains the same, it is considered that there is a high possibility of collision between them. Therefore, the different vehicles 23H and 231 can slow down their vehicle speeds or warn of the presence of a serious danger. In other words, it is considered that it is possible to improve the safety by using the three-dimensional shape of the object or controlling the vehicle or predicting the risk based on the three-dimensional shape of the object.

By the way, the internal information and external information are not limited to information about the object, but can also include information about the peripheral environment. For example, as shown in FIG. 10, it is assumed that a different vehicle 23J is traveling ahead of the subject vehicle 2 on a two-lane road, and a different vehicle 23K is traveling next to the different vehicle 23J. In this case, depending on the detection capabilities of the sensor and the like, it is likely to detect that the different vehicles 23J and 23K are traveling in the same direction at approximately the same position.

In this case, by identifying a boundary line (L1) indicating the boundary between each lane from the image captured by camera 5a, and determining that the different vehicle 23J is traveling in the lane to the left of the boundary line and the different vehicle 23K is traveling in the lane to the right of the boundary line, it the different vehicle 23J and the different vehicle 23K can be recognized individually. By taking into account the positional relationship between the object and the boundary line when determining whether they are the identical target, it is possible to accurately determine whether they are the identical target.

In this way, the vehicle device 1 determines whether the objects are the identical target based on at least one of the following information contained in the internal information and the external information such as the object position, speed, orientation, three-dimensional shape, or the consistency with the peripheral environment, or based on the consistency of multiple pieces of information, or based on the result of weighting each piece of information. Thereby, it is possible to more accurately determine whether they are the identical target.

Further, the type of the internal information can be set by including the type of the internal information in the information transmitted from each vehicle, instead of extracting the feature points as described above. Alternatively, the type of internal information can be determined as a type having the similar appearance by comparing the appearance of the object identified in the image captured by the camera 5a with a database 11a that stores a plurality of images of vehicles, for example.

Further, according to also such a configuration, it is possible to integrate information related to the identical target among objects in the internal information and the external information that are acquired from different sources. The same effects as in the first embodiment can be obtained, such as the ability to quickly process information about the identical target.

### Third Embodiment

Hereinafter, a third embodiment will be described. In the third embodiment, a method for adjusting the amount of information will be described. Although the external information is adjusted in a similar manner, here, for the sake of simplicity, the setting in the vehicle device 1 will be described as an example. Further, since the configuration of the vehicle device 1 is common to the other embodiments, the description will be given with reference to FIGS. 1 to 10 as well. Further, a part of the configuration of the third embodiment is also related to the method of setting the internal information described in the second embodiment. That is, the third embodiment can be combined with the first and second embodiments.

### (Adjustment of Information Amount of Integrated Information)

First, a configuration for adjusting the amount of information when integrating information will be described. In the first embodiment, the individual pieces of information contained in the acquired external information are selected or averaged, but the vehicle device 1 can select the information to be integrated using specific determination criteria.

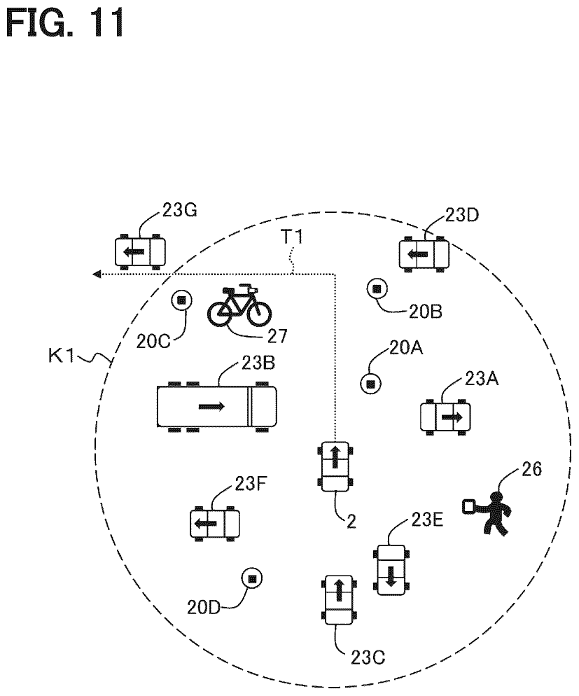

For example, as shown in FIG. 11, a situation is assumed in which a plurality of roadside devices 20A to 20D are installed within a communication range (K1) of V2X communication of the subject vehicle 2, and a plurality of different vehicles 23A to 23G that are compatible with V2V are present. In addition, when the pedestrian 26 or the bicycle 27 has a device capable of communicating with the vehicle, it is assumed that the amount of acquired external information will further increase. However, for the sake of simplicity, it is assumed here that external information can be received from the roadside devices 20A to 20D and the different vehicles 23C to 23E.

In this case, the subject vehicle 2 can integrate all the external information acquired from a plurality of sources. However, when the amount of acquired external information is large, there is a risk that the load on the integration process or the processing of the integration information will increase or be delayed. Therefore, the vehicle device 1 can rank the received external information and select the external information that is the integration target, or select information that is the integration target in the external information.

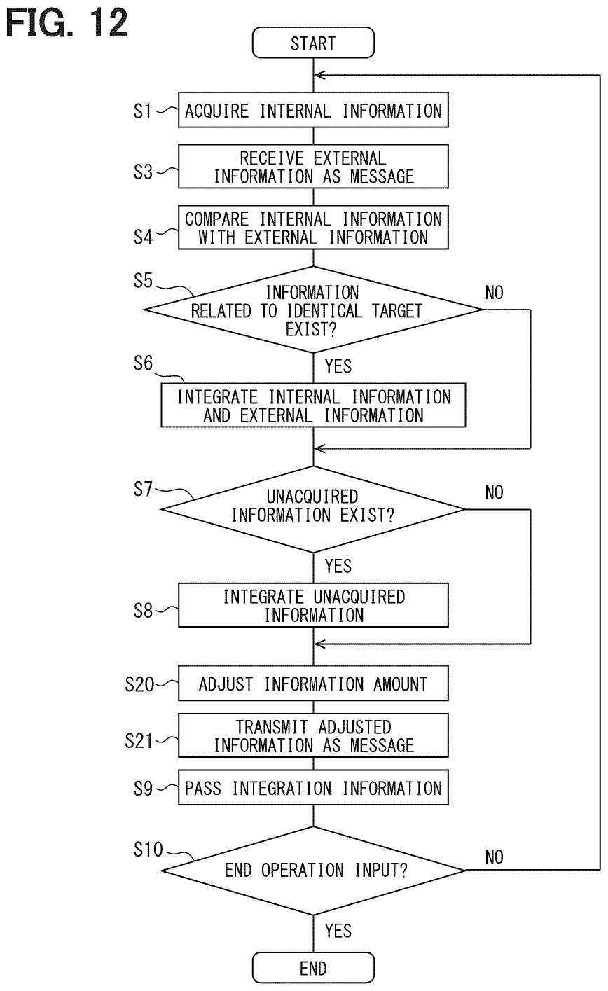

The vehicle device 1 adjusts the amount of information by executing an information integration adjustment process shown in FIG. 12. In FIG. 12, steps that are substantially the same as those in the information integration process described in the first embodiment are denoted by the same reference numerals, and detailed description thereof will be omitted.

First, the vehicle device 1 acquires internal information (S1), and upon acquiring external information (S3), compares the internal information with the external information (S4). When there is information related to the identical target (S5: YES), the information related to the identical target is integrated (S6). Further, when there is unacquired information (S7: YES), the vehicle device 1 integrates the unacquired information (S8).

At this time, the vehicle device 1 determines the distance between the acquisition source and the subject vehicle 2 based on information such as the X coordinate, Y coordinate, and orientation contained in the plurality of pieces of acquired external information, and can select a predetermined number of pieces of external information as integration targets, in order, from the external information acquired at locations close to the vehicle 2. In the situation shown in FIG. 11, it is assumed that the closest distance order to the subject vehicle 2 is the roadside device 20A, the different vehicle 23E, the different vehicle 23C, the roadside device 20D, the roadside device 20B, the roadside device 20C, and the different vehicle 23D. In this case, the vehicle device 1 can preferentially select, as integration targets, pieces of external information up to a predetermined upper limit number in order from the closest information. However, the upper limit number can be set appropriately depending on the processing capacity of the vehicle device 1, and the like.

Further, the vehicle device 1 can preferentially select, from among a plurality of pieces of external information, external information that contains information about an object approaching the subject vehicle 2 or an object that is expected to approach the subject vehicle 2, as the integration target. In the situation shown in FIG. 11, the different vehicle 23C is traveling in the same direction as the subject vehicle 2, and the different vehicle 23D is traveling toward the road on which the subject vehicle 2 is traveling, so it is considered that the different vehicles 23C and 23D are likely to approach the subject vehicle 2.

In this case, the vehicle device 1 can preferentially select, as the integration target, the external information acquired from the different vehicles 23C and 23D, which are expected to have a large influence on the control and risk prediction of the subject vehicle 2. When there is processing capacity to spare, other external information can be obtained based on distance, for example.

Further, the vehicle device 1 can preferentially select the external information transmitted from the roadside device 20 as the integration target. Generally, the roadside devices 20 are considered to have standardized communication standards, sensor performance, and the like, and are also considered to be subject to regular inspections, and the like. Therefore, the external information acquired by the roadside device 20 is considered to be highly reliable. Therefore, the vehicle device 1 can preferentially select the external information acquired from the roadside device 20 as the integration target. When there is processing capacity to spare, other external information can be obtained based on the distance or the positional relationship with the subject vehicle 2, for example.

Further, the vehicle device 1 can preferentially select, for example, external information acquired along a traveling schedule route (T1) set by the navigation function or in the vicinity of the traveling schedule route, as the integration target. When the communication range is wider than the detection range of the vehicle sensor 5, information about objects not detected by the subject vehicle 2 can be acquired as the external information. Therefore, by integrating information acquired from sources in the vicinity of the traveling schedule route, it is possible to predict the risk on the traveling schedule route in advance. Thereby, it is possible to improve the safety.

Further, the vehicle device 1 can select individual pieces of information included in the external information, rather than selecting the external information itself. For example, it is assumed that the roadside device 20C has detected the different vehicle 23G and the bicycle 27 in the vicinity of the traveling schedule route, and the external information includes the individual information that the different vehicle 23 is moving away from the subject vehicle 2, and that the bicycle 27 is moving toward the subject vehicle 2.

In this case, the vehicle device 1 can individually select information about an object moving in a direction approaching the subject vehicle 2 from the external information received from the roadside device 20C as the integration target. Thereby, it is possible to acquire information that is expected to have a large influence on the control of the subject vehicle 2 and on risk prediction as the integration information, and improve the safety.

In this way, the vehicle device 1 does not integrate all of the received external information, but selects and integrates the external information and individual pieces of information contained in the external information based on a predetermined determination criterion. Thereby, it is possible to reduce the risk of an excessively large processing load or processing delays due to an increase in the amount of integration information.

### (Adjustment of Information Amount of Integrated Information)

Next, a configuration for adjusting the amount of integrated information will be described. When the vehicle device 1 integrates information in an information integration adjustment process shown in FIG. 12, the vehicle device 1 adjusts the amount of information of the integrated information (S20). At this time, the amount of information is adjusted by the adjustment unit 10e. However, the information adjustment referred to here includes a configuration for increasing the amount of information in order to improve the convenience and usefulness of the information shared with the external device, and a configuration for reducing the amount of information for transmission to the external device in order to reduce the communication load mainly in V2X communication.

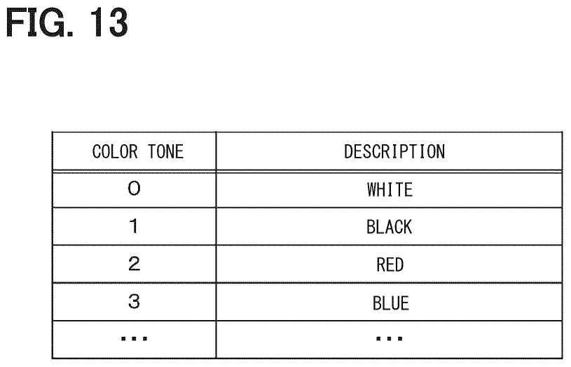

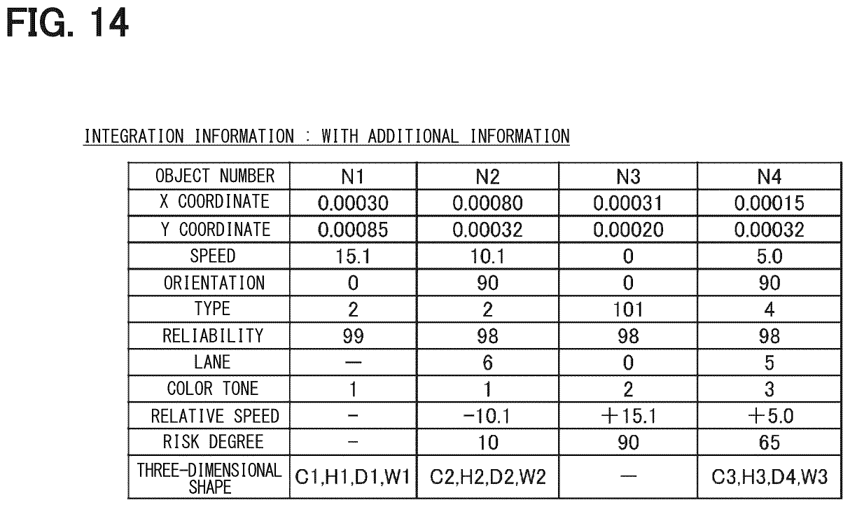

First, a configuration example in which the amount of information is adjusted by adding information will be described. As described above, the vehicle device 1 can detect the color of an object by using the camera 5a. It is considered that when the color of an object is notified to the user, it becomes easier for the user to visually grasp the object. Therefore, the vehicle device 1 provides a color tone item that indicates the color of the object as shown in FIG. 13, and assigns an identification number corresponding to the color. Thereby, the color of the detected object is added as additional information to the integration information as shown in FIG. 14.

Thereby, it becomes possible to notify, for example, “There is a red fallen object” when predicting a risk regarding N3, which is the fallen object 29. The user can easily identify the fallen object 29 when approaching the fallen object 29. It is considered that it is possible to improve the safety.

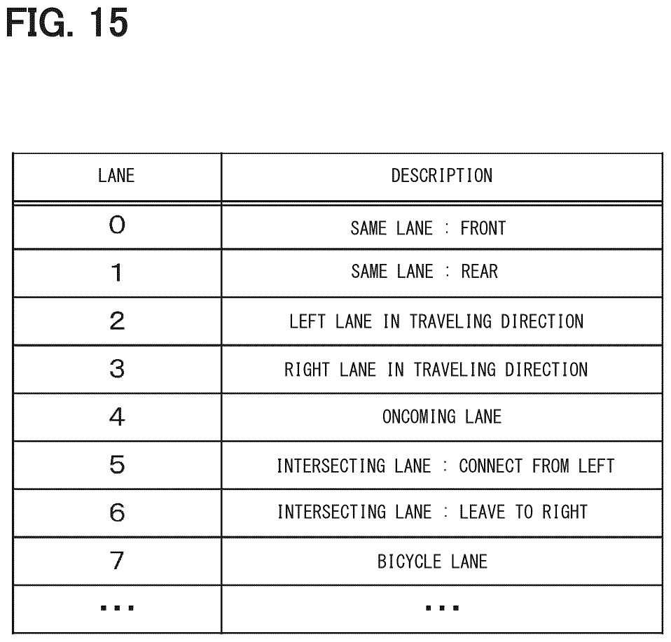

Further, when the boundary line or center line is grasped by the camera 5a as described above, an item of the lane in which the object is located is provided as shown in FIG. 15, and an identification number corresponding to the lane and an identification number indicating the relative positional relationship with the subject vehicle 2 are given. Thereby, the lane in which the detected object exists is added as additional information to the integration information as shown in FIG. 14. For example, assumed lanes include: the same lane as the subject vehicle 2; the front and same lane; the rear lane with the traveling direction on the left side, the rear lane with the traveling direction on the right side, the oncoming lane, the intersecting lane: a lane connecting from the left, an intersecting lane; and a lane for leaving to the right, a bicycle lane for the bicycle 27. However, what is shown here is just an example, and the classification and number of lanes are not limited to these.

Thereby, it becomes possible to notify, for example, “There is a red fallen object on the traveling route” when predicting a risk regarding N3, which is the fallen object 29. When the user approaches the fallen object 29, the user can easily grasp which is the fallen object 29 and whether the fallen object 29 is likely to come into contact with the user. It is considered that it is possible to improve the safety.

In this way, the vehicle device 1 can increase the convenience and effectiveness of the integrated information by adding some information to the integrated information, in other words, by adjusting the integrated information to increase the amount of information.

Next, a configuration example for adjusting the amount of information by reducing the information will be described. By transmitting the above-described integration information to the external device, it becomes possible to share the information by the external device. However, when the integration information is transmitted as is, there is a risk that the communication load of V2X communication is likely to increase or bandwidth is likely to be insufficient. Further, although the above-described additional information is effective for the subject vehicle 2, it may not necessarily be required for the different vehicle 23 or the external device.

Therefore, when adjusting the amount of information in S20 shown in FIG. 12, the vehicle device 1 generates transmission information to be transmitted to the external device by reducing the amount of information. At this time, the vehicle device 1 adjusts the amount of information by filtering the integration information based on a predetermined selection criterion. The selection criteria may be, for example, as follows, but the selection criterion shown here are merely examples and other selection criterion may also be set.
Time to collision between subject vehicle 2 and object (TTC: Time-To-Collision)
Distance between subject vehicle 2 and object
Reliability of information about object
Type of object
Whether information about object is included in internal information
Whether information about object is included in external information
Whether number of objects reached certain upper limit

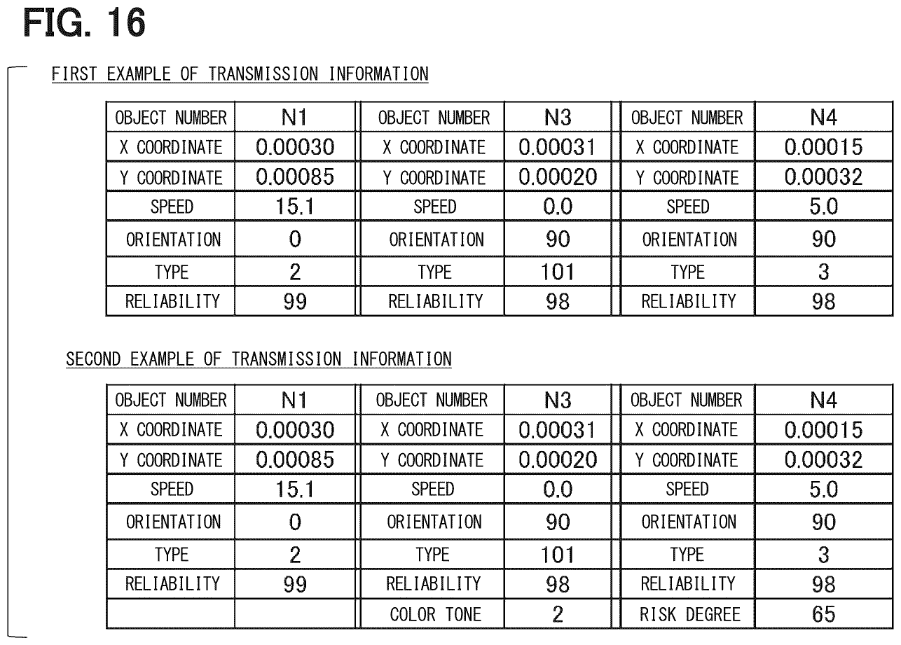

Then, the vehicle device 1 filters the integration information to which the additional information shown in FIG. 14 has been added, according to one of the selection criteria or according to a plurality of conditions. For example, the vehicle device 1 extracts, from the integration information shown in FIG. 14, N1, which is the subject vehicle 2, N3, which is not included in the external information, and N4, which is close to the subject vehicle 2, as transmission targets, as shown in a first example of transmission information in FIG. 16. On the other hand, N4, which is integrated from external information, is excluded from the transmission targets. In addition, the state that the distance to the object is short suggests that the TTC is short and the risk is high, although this depends on the directions of movement of the object and the subject vehicle 2.

In addition, the vehicle device 1 extracts the X coordinate, Y coordinate, speed, type, direction, and reliability from the items of information about the extracted object, and basically reduces information such as lane, color tone, and relative speed used by the subject vehicle 2. Thereby, transmission information is generated and has a reduced amount of information compared to the integration information shown in FIG. 14. The transmission information may be generated and stored as information separate from the integration information. However, it is also possible to dynamically generate and transmit information at the time of transmission by extracting information from the integration information according to the above-described selection criterion.

In addition, the vehicle device 1 can change or add items for each object, as shown in a second example of the transmission information in FIG. 16. This is because it is assumed that the number of objects to be transmitted does not reach a predetermined upper limit when selected according to the selection criterion. This is because in that case, it is considered that there is a margin of communication bandwidth.

Therefore, the vehicle device 1 can include other objects as targets of transmission according to the priority set in the selection criteria, or increase the amount of information related to the object as the transmission target. For example, the vehicle device 1 can include information in the transmission information that can make it easier to visually grasp the object as described above by including a color tone for N3, which is the fallen object 29. Alternatively, for N4, which is likely to contact and is considered to have a relatively high risk, the vehicle device 1 can include, in the transmission information, information about the degree of risk recognized by the subject vehicle 2 itself.

After adjusting the amount of information, the vehicle device 1 transmits a message in which the transmission information is encoded in a predetermined format to the outside, as shown in FIG. 12 (S21). Thereby, information transmitted from the subject vehicle 2 can be received by the external device. It is possible to share the information.

In this manner, the vehicle device 1 adjusts the amount of transmission information. Thereby, since the amount of transmission information is reduced compared to the amount of all information held by the subject vehicle 2, it is possible to reduce the communication load in V2X communication. In addition, when there is sufficient bandwidth available for V2X communication, it is possible to share more information.

In this case, the vehicle device 1 does not generate the transmission information from the integration information to which the addition information is added as described above, and generates the transmission information from the integration information to which no addition information is added and generates the transmission information from the acquired internal information.

According to also such a configuration, it is possible to integrate information related to the identical target among objects in the internal information and the external information that are acquired from different sources. The same effects as in the first embodiment can be obtained, such as the ability to quickly process information about the identical target.

Further, when adjusting the amount of information in S20, the vehicle device 1 can be configured to adjust the amount of information of the internal information acquired in S1. In other words, the vehicle device 1 is not limited to being configured to adjust the amount of information of the integration information as described above, but can be configured to reduce the communication amount when it is transmitted as a message by adjusting the amount of pre-integrated information. Further, when the vehicle device 1 retransmits external information that has been acquired to the external device as the message, the vehicle device 1 can be configured to reduce the communication amount by transmitting information with a reduced amount of information as the message.

Specifically, the vehicle device 1 can reduce the amount of information by selecting information included in the internal information acquired in S1 based on, for example, the above-described selection criterion. Then, in S21, the vehicle device 1 transmits the information with the deleted information amount to the external device as a message. Thereby, it is possible to reduce the communication amount in the V2X communication with the external device. In this way, the amount of information transmitted as the message can be reduced. Thereby, it is possible to reduce the risk of insufficient resources such as communication bands, and also implement rapid communication since it is considered that communication time can be shortened when the amount of information is small.

Further, not only the subject vehicle 2 but also the roadside device 20 and other vehicles 23 can be configured to reduce the amount of information before transmitting it as the message when transmitting information that they have acquired to the outside as the message. Thereby, it is possible to reduce the risk that the communication band is insufficient and also implement rapid communication not only between the subject vehicle 2 and the external device but also, for example, between devices capable of V2X communication such as between the roadside device 20 and the different vehicle 23, between the different vehicles 23, and between the roadside devices 20, in other words, in the information sharing system 30.

Further, the configuration for reducing the amount of information transmitted as a message can be applied to the information integration configuration as described above. Specifically, for example, when transmitting the integration information to which the additional information has been added as the message, the information can be reduced before being transmitted as the message. This configuration also makes it possible to reduce the communication amount, reduce the risk of a shortage of communication bands, and achieve rapid communication.

### Other Embodiments

The vehicle device 1 may be configured as a dedicated device for integrating information, but may also be configured to be shared with or used for a navigation device, for example. In this case, the display device 3 may be configured to be shared with or used for the navigation device. Further, the camera 5a may be configured to be shared with or used for a so-called drive recorder.

In the embodiment, the XY coordinate system is set with a predetermined reference point as the origin, but it is also possible to set, for example, an XY coordinate system with the position of the subject vehicle 2 as the origin, or an XYZ coordinate system with a Z coordinate indicating the elevation difference. In this case, when the current position of the subject vehicle 2 is transmitted at the same time, the external device can grasp the position of the object. Further, it is also possible to perform processing so that the latitude and longitude acquired by GNSS 5e are used directly without conversion to the coordinate system.

Although the embodiment shows the example in which the unacquired information is integrated with no change, whether to integrate the information may be determined based on the X coordinate and the Y coordinate of the unacquired information. Further, it is determined whether the target object is in an area that is impossible or difficult to be detect by the subject vehicle 2. When the object is detectable but has not been acquired, the external information can be acquired again as erroneous information, a possibility of failure occurrence in the sensor of the subject vehicle 2 can be notified to the user.

Although the present disclosure has been described in accordance with embodiments, it is understood that the present disclosure is not limited to such embodiments or structures. The present disclosure includes various modifications or deformations within an equivalent range. In addition, various combinations or forms, and further, other combinations or forms including only one element, one more elements, or one or less elements are also included in the scope or spirit of the present disclosure.

The controller and the method thereof of the present disclosure may be implemented by a dedicated computer provided by configuring a processor and a memory programmed to execute one or more functions embodied by a computer program. Alternatively, the controller and the method described in the present disclosure may be implemented by a dedicated computer provided by forming a processor with one or more dedicated hardware logic circuits. Alternatively, the controller and the method described in the present disclosure may be implemented by one or more dedicated computers including a combination of a processor and a memory programmed to execute one or multiple functions and a processor including one or more hardware logic circuits. Further, the computer program may store a computer-readable non-transitional tangible storage medium as an instruction to be performed by the computer.

Here, the process of the flowchart or the flowchart described in this application includes a plurality of sections (or steps), and each section is expressed as, for example, S1. Further, each section may be divided into several subsections, while several sections may be combined into one section. Furthermore, each section thus configured may be referred to as a device, module, or means.

What is claimed is:

1. A vehicle device comprising:
an acquisition unit configured to acquire internal information detected by a sensor mounted on a subject vehicle;
a comparison unit configured to compare the internal information with external information that is acquired outside the subject vehicle via a communication unit mounted on the subject vehicle;
a determination unit configured to determine whether both of the internal information and the external information include information related to an identical target based on a comparison result by the comparison unit; and
an integration unit configured to integrate the information that is acquired from a plurality of different sources and related to the identical target based on a determination result by the determination unit.

2. The vehicle device according to claim 1, wherein
the integration unit is configured to integrate information related to a mobile object.

3. The vehicle device according to claim 1, wherein
the integration unit is configured to integrate information related to the subject vehicle.

4. The vehicle device according to claim 1, wherein
the integration unit is configured to perform integration that enables utilization for controlling traveling of the subject vehicle.

5. The vehicle device according to claim 1, wherein
the integration unit is configured to perform integration that enables utilization for notification to a user.

6. The vehicle device according to claim 1, wherein
the integration unit is configured to integrate the information based on each information reliability when the acquired information related to the identical target in the internal information is different from the acquired information related to the identical target in the external information.

7. The vehicle device according to claim 1, wherein
the integration unit adds, as acquired information that is not acquired by the subject vehicle, information that is not in the internal information and is in the external information to an integration target.

8. The vehicle device according to claim 1, wherein
the integration unit adds, as acquired information that is not acquired by the subject vehicle, information that is in the internal information and is not in the external information to an integration target.

9. The vehicle device according to claim 1, wherein
the determination unit is configured to determine whether the identical target exists based on at least one information of a position of an object in the internal information and the external information, a speed of the object, an orientation of the object, a three-dimensional shape of the object, or a consistency with a peripheral environment.

10. The vehicle device according to claim 1, further comprising
an adjustment unit configured to adjust an information amount according to a predetermined selection criterion.

11. An information integration method for a vehicle and for integrating information acquired from a plurality of different sources of a vehicle, the method comprising:
acquiring internal information detected by a sensor mounted on a subject vehicle;
comparing the internal information with external information that is acquired outside the subject vehicle via a communication unit mounted on the subject vehicle;
determining whether both of the internal information and the external information include information related to an identical target; and
integrating the information that is acquired from the plurality of different sources and related to the identical target based on a determination result.

12. A vehicle device comprising:
a processor; and
a memory coupled to the processor and storing program instructions that when executed by the processor cause the processor to at least:
acquire internal information detected by a sensor mounted on a subject vehicle;
compare the internal information with external information that is acquired outside the subject vehicle;
determine whether both of the internal information and the external information include information related to an identical target based on a comparison result of the internal information with external information; and
integrate the information that is acquired from a plurality of different sources and related to the identical target based on a determination result of whether both of the internal information and the external information include the information.
